(19) United States
(12) Patent Application Publication
(10) Pub. No.: US 2010/0193435 A1
(43) Pub. Date: Aug. 5, 2010

(54) Method for the Filtration of a Fluid

(75) Inventors: Bastiaan Blankert, Enschede (NL); Brian Roffel, Hengelo (NL); Harry Futselaar, Hengelo (NL); Frederik Jan Spenkelink, Vriezenveen (NL)

Correspondence Address: PEACOCK MYERS, P.C., 201 THIRD STREET, N.W., SUITE 1340, ALBUQUERQUE, NM, 87102, US

(73) Assignee: NORIT Process Technology B.V., Enschede (NL)

(21) Appl. No.: 12/569,345

(22) Filed: Sep. 29, 2009

Related U.S. Application Data
(63) Continuation of application No. PCT/NL2008/050126, filed on Mar. 4, 2008.

(30) Foreign Application Priority Data
Mar. 30, 2007 (NL) 1033622
Apr. 11, 2007 (NL) 2000586

(51) Int. Cl. B01D 65/02

(52) U.S. Cl. 210/636

(57) ABSTRACT

A method for the filtration of a fluid applying a certain preferred setting of one or more process parameters (e.g. a minimal concentration of coagulants) while maintaining desirable process performance by regulating the initial filtration resistance. This is achieved by a feedback controller. Applying the invention on in-line coagulation during membrane filtration has shown, that the initial resistance of the last filtration before the chemical cleaning phase can be controlled within an accuracy of approximately 3% (of the total resistance) or 9% (of the fouling resistance). Compared to current dosing strategy, a significant reduction in coagulant consumption can be achieved.

### CROSS-REFERENCE TO RELATED APPLICATIONS

This application is a continuation application of International Patent Application Serial No. PCT/NL2008/050126, entitled “Method for the Filtration of a Fluid”, to NORIT Process Technology B.V., filed on Mar. 4, 2008, and the specification and claims thereof are incorporated herein by reference.

This application claims priority to and the benefit of the filing of Netherlands Patent Application Serial No. NL 1033622, entitled “Control System for In-Line Fouling Control in a Filter Medium Filtration Process”, filed on Mar. 30, 2007, and the specification and claims thereof are incorporated herein by reference.

This application claims priority to and the benefit of the filing of Netherlands Patent Application Serial No. NL 2000586, entitled “A Method for the Filtration of a Fluid”, filed on Apr. 11, 2007, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field)

The invention relates to the filtration of fluids in general using a filter medium. To clean these filters or to restore their original performance all kind of cleaning methods are available, generally specifically developed for a certain filtration medium. However, for clarity's sake, the description will be mainly directed to filtration of liquids and membrane filtration in particular using membrane filtration related cleaning methods such as but not limited to backwashing and chemical cleaning.

2. Description of Related Art

Filtration, such as but not limited to membrane filtration and in particular microfiltration or ultrafiltration, is a commonly applied method for the production of potable or process water or treatment of waste water. However, (irreversible) membrane fouling is a limitation in the application of this technology. The accumulation of the retained matter on the membrane surface leads to an increase in operating costs, due to an increased energy consumption and the necessity of periodic cleaning. To reduce these operating costs, it is necessary to control the fouling behavior. Fouling can be distinguished into reversible and irreversible fouling. Reversible fouling is removed readily under the influence of hydrodynamic forces exerted during a backwash or cross-flow operation. Irreversible fouling is not (or very slowly) removed under these conditions. Whether the fouling is reversible or not depends on the interaction between the physiochemical feed water properties, membrane properties and operating conditions.

In water treatment the source of the feed stream can have many origins, such as but not intended to be complete:
Bore hole water
Ground water
Surface water (lake, river)
Sea or brackish water
   Industrial and/or municipal effluent
   Industrial or municipal influent
   All kind of reject or/and bleed (aqueous) streams, such as sand filter backwash water, cleaning-in-place (CIP) waste water, etc.,
      whereas many other liquids are being produced or purified through one or more filtration steps, such as beer, wines, juices, etc.

All these feed streams contain different components which can more or less foul the filter surface or medium in a reversible or irreversible way. This fouling process does not only depend on the fluids to be filtered but also on the properties of the filtering medium itself (such as e.g. pore size, surface charge, or hydrophobicity in case of a membrane). Moreover, the fouling regime can also depend on the process conditions, such as pretreatment, auxiliary filter aids, temperature, pH, cleaning regimes, etc.

Natural water can contain a large number of different components, which makes it difficult to characterize. However, generally it is found that (irreversible) fouling of a membrane by natural organic matter (NOM) is worsened by decreasing pH, increasing electrolyte concentration, increasing NOM molecular weight, increasing NOM hydrophobicity and addition of divalent cations (e.g. Ca²⁺). Due to the complexity of solution chemistry in natural waters, NOM properties are very source specific and both seasonal and long-term trends occur.

Regarding the membrane properties, it is observed that irreversible fouling is enhanced if the membrane is rough, hydrophobic or if the pore size is approximately equal to the particle size. For other filter media other process specific filter media properties will have comparable effects on the fouling behavior of the filter medium.

In the state of the art, methods for removing fouling from a membrane are known. The effectiveness of these methods can be enhanced by, for example, a pre-treatment method to counter irreversible fouling so as to be able to continue membrane filtration operation under economically feasible conditions. Some feed water pre-treatment options for ultrafiltration are: (pre-)coagulation, activated carbon (powdered or granulated) dosing or ozonation. Pre-coagulation comprises two separate steps wherein dosing of a coagulant is followed by conventional flotation or sedimentation. The supernatant is then used as feed for the filtration process. The present invention, however, is demonstrated for in-line coagulation, which is the application of a coagulant before membrane filtration without a flotation/sedimentation or pre-filtration step. However, other process parameters can be chosen dependent on the filtration process.

Besides in-line coagulation other methods for removing fouling from a membrane filter are:
Forward flushing (cross-flowing) with all kind of media such as the liquid to be filtered itself, other liquids (e.g. the permeate) or a mixture of liquids and gases;
Backwashing;
Chemical enhanced backwash
Cleaning-in-place
Relaxation of the system
Any combination
Etc. depending on the filtering process and its filter medium.

For the description of the invention the applied cleaning method is not of importance and the action to be taken will be specific for a certain type of fouling and will be determined by an experienced or skilled person.

### BRIEF SUMMARY OF THE INVENTION

According to the present invention, the method as indicated in the preamble comprises the steps as indicated in claim 1. Preferred embodiments of the methods are mentioned in the dependent claims. The preference and advantage of the method steps in each individual claim will become apparent from the description and the Examples. Depending on the filtration process many process parameters can be defined and used to control the process, such as:

1. filter aid dosing, such as coagulant

2. changing of feed properties, such as temperature (viscosity), pH, etc.

3. changing filter medium properties, such as surface charge, packing density, etc.

4. production (flux) level

5. production time

6. back flush level

7. back flush time

8. (chemical) cleaning time and flux level

9. hydrodynamic conditions, such as liquid or gas velocities (continuous or intermittent)

10. (chemical) cleaning conditions, such as chemical type, concentration, frequency, time, temperature, combinations of parameters, etc.

11. any combinations of two or more of the above-mentioned process parameters

12. any combinations of (optionally dimensionless) ratios based on two or more of the above-mentioned proceβs parameters and characteristic filter medium dimensions (like Re-number, Fanning-factor and the like)

13. etc.

### DETAILED DESCRIPTION OF THE INVENTION

The advantage that is obtained with the method according to the present invention, during which the resistance is kept between predetermined set values during the filtration, is that the degree of irreversible fouling is kept low and any fouling obtained can be removed easily using an appropriate cleaning method. According to a preferred embodiment of the present invention a coagulant is added, as a consequence of which the resistance value is limited and the fouling will stay reversible to a large extent.

Preferred embodiments are specifically mentioned in the dependent claims. However, a person skilled in the art is readily able to amend the embodiments described to provide alternatives that are all part of the present invention.

The advantage of the invention is now exemplified by reference to the use of a coagulant, that is used to decrease the resistance. However, instead of using the coagulant concentration as control parameter any other appropriate control parameter (or set of control parameters) can be chosen which is able to decrease the resistance in the forthcoming filtration interval. The interval is defined as the time frame in which preferably no control parameter will be changed and the course of the filtration resistance will be followed in time. However, if in the predefined filtration interval the filtration resistance increases too much a intermediate change in a control value can be initiated to avoid the occurrence of an irreversible fouling, or in the ultimate case the filtration sequence can be interrupted and the normal or even an enhanced filter cleaning can be performed. Next the resistance is determined again, one or more control parameters are changed and the filtration starts again based on the new settings.

In general the resistance is measured at the beginning of each filtration step. This can also be done at the end of each cleaning cycle, thus after a backwash or chemically enhanced backwash, which generally are the same moments in time. More in general, the determination of the resistance can also be carried out in any filtration interval at a distinguished start and end point after which these values are compared with a set of reference values. On the basis of this measurement, the amount of coagulant {or the value of any other control parameters) is determined. If, during the filtration, the resistance increases up to a predetermined value, the filter is cleaned, for example by means of a backwash or a chemical cleaning, as is generally known in the art. The choice of the maximum resistance value can be determined on the basis of known behavior of the filter, for example at which value an irreversible fouling is obtained.

As far as an addition of a coagulant (also known by the term “filter aid”) is regarded, the present invention is directed to a method of in-line coagulation, so as to improve filtration of a liquid with a membrane filter. It has shown, that in-line coagulation to some extent can be of benefit for the performance of the filtration process. For example, a reduction in the hydraulic resistance of the fouling layer can be observed. This suggests that either a more permeable cake is formed or the internal membrane surface is better protected against foulants. Furthermore, hydraulic cleaning is more effective. Finally, the permeate quality is better due to enhanced NOM and turbidity removal. This potentially improves the performance of subsequent process steps (for example RO/NF) and reduces the concentration of disinfection byproduct precursors.

However, application of in-line coagulation as used in the state of the art does have drawbacks. Firstly, it forms a large portion of the operating costs, due to chemicals consumption and the increased disposal costs of the concentrate stream. Secondly, coagulant residuals in the permeate, caused by overdosing, reduce the product quality and can lead to issues in downstream processes, for example RO. In some cases it is even observed that dosing of coagulant adversely affects the performance of membrane filtration.

Hence, according to a preferred embodiment of the present invention, it is a goal to provide a good dosing strategy of a coagulant, which applies the minimum addition at which the filtration process shows a desired performance. This is different from the conventional optimum coagulant concentration according to the state of the art, which is aimed at the concentration at which good sedimentation results are obtained. The advantage of the present invention is that, compared to the conventional optimum, underdosing still leads to both good filtration properties and good removal of NOM. This observation further motivates the desire for a method for minimal dosing of coagulants.

In the art it is common practice to apply the optimal conventional dose, usually found by jar tests, or to test a number of concentrations in a pilot plant study and selecting the most appropriate one. However, if the dosing is not continuously adapted to seasonal and long-term trends in the water composition, alteration of other operating settings and gradual changes in membrane properties, it can be expected that under- or overdosing will occur. According to the present invention, this adaptation is achieved by feedback control.

### DETAILED DESCRIPTION OF THE INVENTION

The present invention relates to a control system comprising the following steps: measuring a filter resistance value; comparing the measured filter resistance value with a set of predetermined filter resistance values and corresponding setting of one or more process control parameters (such as but not limited to coagulant dosing values); and determining a corresponding value of the control parameter (e.g. the coagulant dosing value) from said set.

The primary goal of in-line coagulation is stabilization of the filtration process; improvement of permeate quality by enhanced NOM removal is of secondary importance. According to the present invention, only stabilization of the filtration sequence is considered. Hence, the amount of fouling that is allowed to accumulate between two intensive cleaning phases (such as chemical cleaning phases in membrane filtration) needs to be kept within certain bounds.

To realize the control objective, it should first be quantified. The resistance is a good measure for the amount of fouling present in the system and will serve as controlled variable. The resistance is the sum of the membrane resistance R_{M} and a progressively growing fouling resistance R_{f}. In the case of membrane filtration, Darcy' s law relates the resistance to the flux J, the transmembrane pressure ΔP and the viscosity η:

$${R}_{M} + Rf = \frac{Δ P}{{η}^{J}} \qquad ( 1 )$$

FIG. 1 sketches the resistance during a series of subsequent filtrations and backwashes between two chemical cleaning phases. The initial resistance Ro is the resistance at the end of a backwash or the start of a filtration phase. The objective, stabilization of the filtration sequence, is to control the final resistance before the chemical cleaning.

In principle, the operating variable that has the most influence on the controlled variable should be chosen as the manipulated variable. The coagulant concentration and the filtration flux are the variables that most clearly influence the reversibility. The coagulant concentration is chosen, because the reversibility is very sensitive to changes in this concentration. Furthermore, the filtration flux is directly related to the produced volume. In many situations the produced volume is determined by external demand or economic considerations, and thus the filtration flux cannot be manipulated freely.

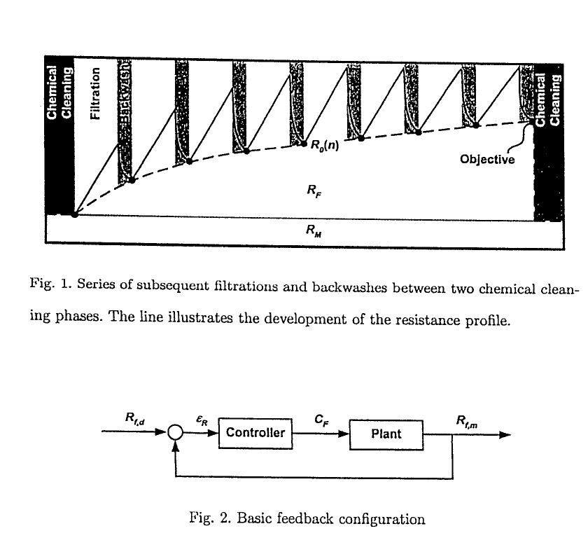

The control configuration is the structure in which the information flows from the available measurement to the manipulated variable. The interaction between the physiochemical feed water properties and the membrane surface under the influence of the coagulant dosing and other operating conditions is very complex. A feedback controller is selected because feedback is able to deal with systems of which the behavior is not exactly known. The control configuration, where feedback is used to adapt the coagulant dosing to control the initial resistance, is shown in FIG. 2.

Typically, a feedback controller is used to keep the controlled variable at an invariant set point. However, the control objective does not require us to keep the amount of fouling constant, providing that the final value is acceptable. The natural shape of a filtration sequence curve shows some accumulation of foulants over the subsequent filtrations. Based on the shape of the observed resistance trajectories, an expression for a desired initial resistance trajectory as a function of the cumulative filtered volume per unit area (V_{F}) is assumed:

Ro_{,d}(V_{F})=R_{M}+αiV_{F}+Rᵣ*(1−e^{-VF/Veq}) (2)

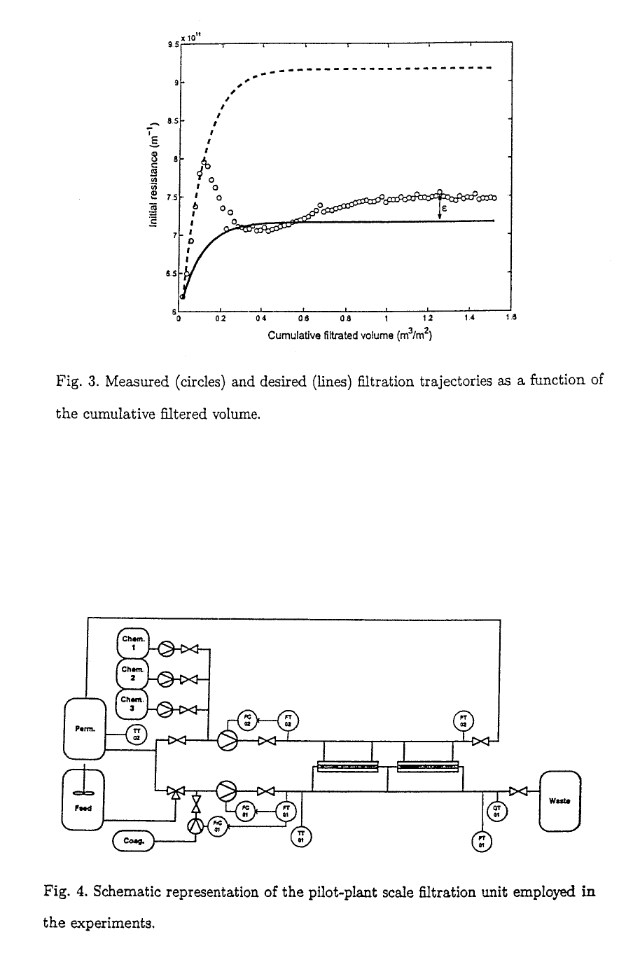

It is assumed that the initial resistance of the first filtration following a chemical cleaning phase is the membrane resistance R_{M}. This leaves us three degrees of freedom to define a trajectory, αi is the final slope, Rᵣ is gain of the exponential rise and V_{eq} is its characteristic volume. The resulting trajectory can be linear, exponential or a combination. Two examples of desired initial resistance trajectories are shown in FIG. 3 and depicted by a solid and a dashed line. The circles in the figure represent measured values of the initial resistance for a number of subsequent filtration phases. When the solid line in the figure is chosen as desired trajectory, ε indicates the difference between the measured and desired initial resistance, which is the control error. With F the filtration number, the desired initial resistance trajectory Ro,_{d} (V_{F} (η_{F}) and the measured initial resistance Rₒ(η_{F}), the control error can be defined by equation 3.

ε(η_{F})=Ro(η_{F})−Ro,d(V_{F}(η_{F})) (3)

The controller is the algorithm that determines how the information obtained from the process (the control error) is used to adapt the manipulated variable. Since a trajectory for the initial filtration resistance is tracked, the coagulant concentration is adapted one time per filtration, at the moment the initial resistance is estimated. Hence, a discrete PI-controller is used, which may be given in velocity form by:

C(η_{F}+1)=C(η_{F})+K((1+1/ηᵣ)ε(η_{F})−ε(η_{F}−1)) (4)

in which K is the controller gain, ηᵣ is the controller integration interval. The bounds can be given by:

C_{1b}<C(η_{F})<C_{ub} (5)

### Examples

The experiments were performed on a pilot plant scale filtration unit which is schematically shown in FIG. 4. Two Norit-XIGA™ SXL-225 FSFC modules with a filtration surface of 40 m² each were used. These consist of hollow fibre porous PES/PVP membranes with an internal diameter 0.8 mm and an effective length of approximately 1.5 m. The internal fibre volume is approximately 16 1, the additional dead volume of the system is estimated at 8 1.

The feed water was taken from the Twente Canal and pre-filtered (200 μm mesh size) to prevent too large particles from entering the system. The feed water was buffered in a continuously refreshed and well stirred feed tank.

Filtration sequences were preceded by a chemical cleaning procedure. This consisted of 20 minutes soaking in a NaOH solution at pH 11 with an addition of 100 ppm NaOCl. This was followed by 20 minutes soaking in a HCl solution at a pH of 2.

A commercially available poly-alumina coagulant was used. To achieve more accurate dosing the stock solution was diluted by a factor 10. This was done with a mixture of water and hydrochloric acid with the same pH as the stock solution. The coagulant concentration was controlled by flow ratio control on a dosing pump. The mixing point is just before the filtration pump.

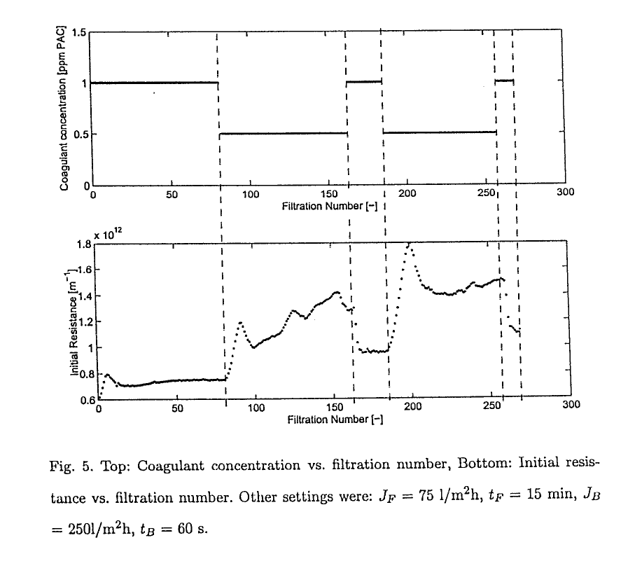

An open loop experiment was performed, the results are shown in FIG. 5. The filtration flux (J_{F}=75 1/m²h), filtered volume (V_{F}=0.025 m³/m²), backwash flux (J_{B}=250 1/m²h) and backwash duration (t_{B}=60 s) were all kept constant. The top graph shows step-changes that were made in the coagulant concentration, whereas the bottom graph shows the effect of these changes on the initial resistances. It can be seen that by lowering the concentration the initial resistance increases and vice versa and that these effects occur within a few filtration phases. This confirms that the coagulant concentration is a suitable control variable.

Looking at FIG. 5 in more detail, it can be seen that during the first 81 filtrations at a concentration of 1.0 ppm, the resistance reached a stable value of 7.45×10¹¹ m⁻¹. After a subsequent period of 83 filtrations at 0.5 ppm, the concentration was increased again to 1.0 ppm. This resulted in a stable resistance of 9.60×10¹¹ m⁻¹. From this it is concluded that the effect of decreasing the concentration is not necessarily reversible by increasing the concentration.

A system is called controllable if by using admissible inputs it is possible to steer the system from any initial state to any final state. Since irreversible fouling cannot be removed, it is by definition not possible to reach any state from any given initial state. Controllability is an important property of systems to be controlled and the intrinsic lack of this property has an important consequence: the set point trajectory needs to be chosen with care to ensure the controller is able to track the desired trajectory. If it is attempted to impose an infeasible set point, the controlled system can be unstable.

From FIG. 5 it is estimated that a change in coagulant concentration of 0.5 ppm results in a resistance change equal to approximately 4×10¹¹ m⁻¹, this is about the same for both increasing and decreasing the coagulant concentration. Based on this process gain, a suitable gain of the coagulant controller should be approximately 1×10⁻¹² ppm m. The number of filtrations needed to achieve most of the change is roughly estimated to be 20. The reaction to an increase in the coagulant concentration is much faster (approximately 5 filtrations). Based on these numbers, the integration interval of the coagulant controller should be chosen equal to approximately 10 filtrations.

The selection of the desired initial resistance trajectory parameters is in principle arbitrary. Thus, a wide variety of trajectories may be realizable, which can be selected to satisfy certain operational objectives. However, the selection of a good or optimal trajectory is beyond the scope of this invention. In consideration of the controllability, the parameters were chosen such that the desired trajectory seems feasible compared to the available measured trajectory. It is defined by equation 2 with αi=0 m⁻², Rᵣ=3×10¹² m⁻¹ and V_{eq}=0.1 m. The resulting curve is plotted as a dashed line in FIG. 3.

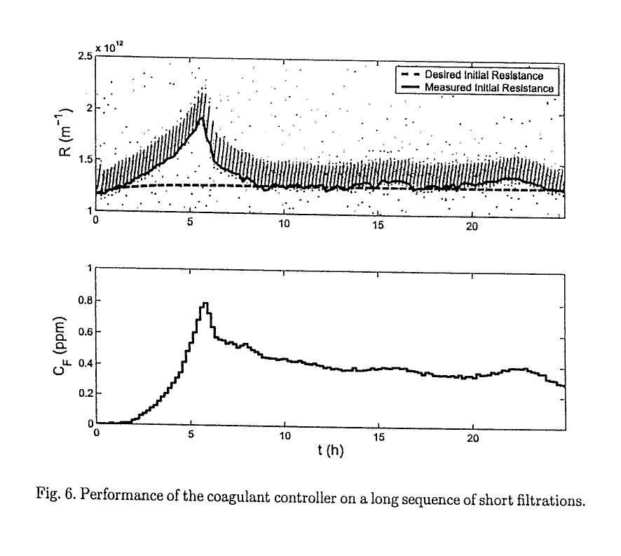

The controller was implemented in the control software of a pilot plant. Its performance is evaluated by applying the control to a sequence of filtrations. The filtration flux (J_{F}=75 1/m² h), the filtration duration (t_{F}=600 s), the backwash flux (J_{B}=250 1/m² h) and the backwash duration (t_{B}=60 s) were all kept constant. The initial concentration of the coagulant was taken as 0 ppm. The result is shown in FIG. 6. The top graph shows the desired and measured resistance and the bottom graph shows the coagulant concentration.

In the first hour (6 filtrations) the measured initial resistance is lower than the predetermined/set (desired) initial resistance. The controller should in that case decrease the coagulant concentration, however, since it is already at its lower bound of 0 ppm, it is maintained at this level. After the first hour, the initial resistance keeps increasing and it becomes clear that filtration with no coagulant dosing leads to an unstable sequence. To compensate for the increasing resistance, the controller keeps increasing the coagulant dose, until after about 6 hours the initial resistance starts decreasing. After approximately 8 hours the initial resistance reaches its set point. From this point onwards only small variations in the coagulant concentration occur, which are used to counter small deviations in the initial resistance.

From FIG. 6 it is concluded that the controller performs well and that no adjustments of the control parameters are necessary.

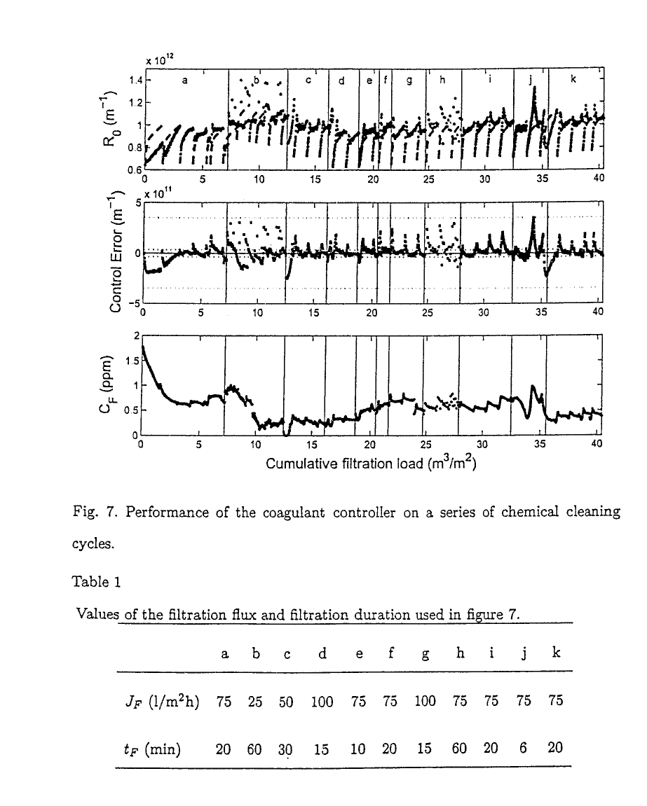

The performance of the controller was also tested on a number of (in this case 40) filtration sequences. Different values for the filtration flux and filtered volume were applied (see Table 1). The desired initial filtration resistance trajectory was defined by equation 2, with αi=1.0×10¹¹ m⁻², Rᵣ=3×10¹² m⁻¹ and V_{eq}=0.1 m. The backwash flux (J_{F}=250 1/m² h) and the backwash duration (t_{B}=45 s) were kept constant. For surface water with a turbidity in the range of 5-15 NTU typically a coagulant concentration of 2 ppm would be used. This was chosen as initial concentration. The results are shown in FIG. 7. The top graph shows the measured and desired initial resistance, the middle graph shows the control error and the bottom graph shows the coagulant dose.

It can be seen that due to the high initial dosing, the measured initial resistances are well below the desired trajectory. Consequently the concentration is lowered. At the third chemical cleaning cycle, the desired trajectory is reached and the coagulant dosing reaches a steady state.

The average control error of the initial resistance of the final filtration phase is approximately 9% of the fouling resistance or 3% of the total resistance. Due to an observed overshoot at the beginning of the sequences and the changes in operational settings the average control error evaluated over the entire trajectory is larger (20% and 7%).

It can be concluded that the designed controller is able to fulfill its objective; the initial resistance of the last filtration before the chemical cleaning phase can be controlled within an accuracy of approximately 3% (of the total resistance) or 9% (of the fouling resistance). It was furthermore found that the controller is able to adapt to changes in operating settings. Compared to the current coagulant dosing strategy a large reduction in coagulant consumption can be achieved.

As is common to a skilled person, other control parameters can be used to control the resistance increase during a filtration interval using the concept of this invention. In a membrane filtration process e.g. the increase in resistance can also be limited by lowering the flux resulting in less deposition of fouling components on the membrane surface causing, however, a decrease in filtration capacity. This last can be acceptable for a certain period of time, but can also be compensated by increasing the amount of membrane area to keep the filtration capacity at its desired level.

What is claimed is:

1. A method for the filtration of a fluid using a filter medium, whereby measuring a fouling status value; comparing the measured fouling status value with a set of predetermined fouling status values and corresponding process parameter values; and determining at least one value of said corresponding process parameter values from said set, wherein the process parameter is chosen from at least one of: coagulant dosing, filtration flux, filtration time, backwash time, cross flow velocity, bleed ration, chemical cleaning agent, soak time, type of cleaning agents, combination of cleaning agents, and relaxation time.

2. A method according to claim 1, whereby manipulating said at least one parameter value preceding said filtration, so as to realize a predetermined increment of a predicted fouling status during a predetermined filtration period.

3. A method according to claim 1, whereby manipulating said at least one parameter value during said filtration.

4. A method according to claim 1, whereby manipulating said at least one parameter value during said filtration, so as to realize a predetermined increment of a predicted fouling status during a predetermined period.

5. A method according to claim 4, wherein the predetermined period is determined by the time interval between two said cleanings after which at least one process parameter is manipulated.

6. A method according to claim 4, whereby determining the predetermined period as the time to reach a maximum increase in the measured fouling status and then manipulating at least one process parameter and/or initiating said cleaning action.

7. A method according to claim 1, wherein the process parameters are comprised of any combination of two or more of these process parameters.

8. A method according to claim 1, wherein the process parameters are determined by (optionally dimensionless) ratios based on two or more of said process parameters and characteristic filter medium dimensions.

9. A method according to any of claim 1, whereby manipulating an amount of coagulant added to the fluid to be filtered, so as to set the fouling status to a predetermined value.

10. A method according claim 1, wherein:
in a first step a fluid is filtrated and wherein the fouling status is measured, wherein at least one process parameter is manipulated so as to keep the fouling status at a predetermined value;
in a second step, if said process parameter has reached a predetermined value, performing a cleaning step of said filter; and
repeating said first and second steps alternately.

11. A method according to claim 10, wherein said process parameter is a coagulant dosing and wherein the predetermined value of the coagulant dosing is a maximum value.

12. A method according to any of claim 10, wherein said fouling status is comprised of a filter resistance value.
